(19) United States
(12) Patent Application Publication
(10) Pub. No.: US 2019/0200245 A1
(43) Pub. Date: Jun. 27, 2019

(54) Systems and Methods for Determining Preferred Location and Orientation of Wireless Broadband Router

(71) Applicant: Phazr, Inc., Allen, TX (US)

(72) Inventors: Farooq Khan, Allen, TX (US); Sudhir Ramakrishna, Plano, TX (US); Rakesh Taori, McKinney, TX (US)

(21) Appl. No.: 15/856,027

(22) Filed: Dec. 27, 2017

(51) Int. Cl. H04W 24/02; H04W 64/00

(52) U.S. Cl. CPC H04W 24/02; H04W 64/003

(57) ABSTRACT

A method of determining a preferred location and orientation of a wireless broadband router includes measuring by the wireless broadband router a first received downlink signal strength corresponding to a first location and orientation and transmitting by the wireless broadband router the first received downlink signal strength. The method includes receiving a first score responsive to the first downlink signal strength. The method includes measuring by the wireless broadband router a second received downlink signal strength corresponding to a second location and orientation and transmitting by the wireless broadband router the second received downlink signal strength. The method includes receiving a second score responsive to the second received downlink signal strength. The method includes receiving a preferred location and orientation information based on the scores.

### BACKGROUND

The invention relates to wireless communications, and in particular relates to systems and methods for determining a preferred location and an orientation of a wireless broadband router.

### DESCRIPTION OF THE RELATED ART

Currently, wireless access methods are based on two popular standards: a wide area network (WAN) standard referred to as The Fourth Generation Long Term Evolution (4G LTE) system; and a local area network (LAN) standard called Wi-Fi. Wi-Fi is generally used indoors as a short-range wireless extension of wired broadband systems, whereas the 4G LTE systems provide wide area long-range connectivity both outdoors and indoors using dedicated infrastructure such as cell towers and backhaul to connect to the Internet.

As more people connect to the Internet, increasingly chat with friends and family, watch and upload videos, listen to streamed music, and indulge in virtual or augmented reality, data traffic continues to grow exponentially. In order to address the continuously growing wireless capacity challenge, the next generation of LAN and WAN systems are relying on higher frequencies referred to as millimeter waves in addition to currently used frequency bands below 7 GHz. The next generation of wireless WAN standard referred to as 5G New Radio (NR) is under development in the Third Generation Partnership Project (3GPP). The 3GPP NR standard supports both sub-7 GHz frequencies as well as millimeter wave bands above 24 GHz. In 3GPP standard, frequency range 1 (FR1) covers frequencies in the 0.4 GHz-6 GHz range. Frequency range 2 (FR2) covers frequencies in the 24.25 GHz-52.6 GHz range. Table 1 provides examples of millimeter wave bands including FR2 bands that may be used for wireless high data-rate communications. In the millimeter wave bands above 24 GHz, a time division duplexing (TDD) scheme is generally preferred. However, regulations in most parts of the world allow using other duplexing schemes including frequency division duplexing (FDD).

TABLE 1
Examples of millimeter wave bands

| | | |
|---|---|---|
| Bands | Frequency | Bandwidth |
| [GHz] | [GHz] | [GHz] |

| | | | |
|---|---|---|---|
| 26 | GHz Band | 24.25-27.5 | 3.250 |

| | | |
|---|---|---|
| LMDS Band | 27.5-28.35 | 0.850 |
| | 29.1-29.25 | 0.150 |
| | 31-31.3 | 0.300 |

| | | | |
|---|---|---|---|
| 32 | GHz Band | 31.8-33.4 | 1.600 |
| 39 | GHz Band | 38.6-40 | 1.400 |
| 37/42 | GHz Bands | 37.0-38.6 | 1.600 |
| | | 42.0-42.5 | 0.500 |
| 47 | GHz | 47.2-48.2 | 1.000 |
| 60 | GHz | 57-64 | 7.000 |
| | | 64-71 | 7.000 |
| 70/80 | GHz | 71-76 | 5.000 |
| | | 81-86 | 5.000 |
| 90 | GHz | 92-94 | 2.900 |
| | | 94.1-95.0 | |
| 95 | GHz | 95-100 | 5.000 |
| 105 | GHz | 102-105 | 7.500 |
| | | 105-109.5 | |
| 112 | GHz | 111.8-114.25 | 2.450 |
| 122 | GHz | 122.25-123 | 0.750 |
| 130 | GHz | 130-134 | 4.000 |
| 140 | GHz | 141-148.5 | 7.500 |
| 150/160 | GHz | 151.5-155.5 | 12.50 |
| | | 155.5-158.5 | |
| | | 158.5-164 | |

Table 2 lists examples of FR1 bands in the 3GPP standard. We refer to the FR1 bands in the 3GPP standard, unlicensed 2.4 GHz and 5 GHz bands, 5.925-6.425 GHz and 6.425-7.125 GHz bands and any other spectrum band below 7 GHz as sub-7 GHz spectrum. The duplexing schemes used in the sub-7 GHz spectrum, among others, can be time division duplexing (TDD), frequency division duplexing (FDD), supplemental downlink (SDL) or supplemental uplink (SUL).

TABLE 2
Examples of FR1 bands in 3GPP

| 5G-RAN | | | |
|---|---|---|---|
| Frequency | Uplink | Downlink | Duplex |
| Band | Frequency band | Frequency band | Mode |
| n1 | 1920 MHz-1980 MHz | 2110 MHz-2170 MHz | FDD |
| n3 | 1710 MHz-1785 MHz | 1805 MHz-1880 MHz | FDD |
| n7 | 2500 MHz-2570 MHz | 2620 MHz-2690 MHz | FDD |
| n8 | 880 MHz-915 MHz | 925 MHz-960 MHz | FDD |
| n20 | 832 MHz-862 MHz | 791 MHz-821 MHz | FDD |
| n28 | 703 MHz-748 MHz | 758 MHz-803 MHz | FDD |
| n41 | 2496 MHz-2690 MHz | 2496 MHz-2690 MHz | TDD |
| n66 | 1710 MHz-1780 MHz | 2110 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n77 | 3300 MHz-4200 MHz | N/A | TDD |
| n78 | 3300 MHz-3800 MHz | N/A | TDD |
| n79 | 4400 MHz-5000 MHz | N/A | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1980 MHz | N/A | SUL |

In addition to serving mobile devices, the next generation of wireless WAN systems using millimeter wave and sub-7 GHz spectrum is expected to provide high-speed (Gigabits per second) links to fixed wireless broadband routers installed in homes and commercial buildings.

### SUMMARY

According to disclosed embodiments, a method of determining a preferred location and orientation of a wireless broadband router includes measuring by the wireless broadband router a first received downlink signal strength corresponding to a first location and orientation and transmitting by the wireless broadband router the first received downlink signal strength. The method includes receiving a first score responsive to the first downlink signal strength. The method includes measuring by the wireless broadband router a second received downlink signal strength corresponding to a second location and orientation and transmitting by the wireless broadband router the second received downlink signal strength. The method includes receiving a second score responsive to the second received downlink signal strength. The method includes receiving a preferred location and orientation information based on the scores.

According to other disclosed embodiments, a method of determining a preferred location and orientation of a wireless broadband router includes identifying by the wireless broadband router its first location and orientation and measuring by the wireless broadband router a first received downlink signal strength corresponding to the first location and orientation. The method includes transmitting by the wireless broadband router the first received downlink signal strength and the first location and orientation information. The method includes receiving a first score corresponding to the first location and orientation. The method includes moving the wireless broadband router to a second location and orientation and identifying the second location and orientation. The method includes measuring by the wireless broadband router a second received downlink signal strength corresponding to the second location and orientation and transmitting by the wireless broadband router the second received downlink signal strength and the second location and orientation information. The method includes receiving a second score corresponding to the second location and orientation. The method includes receiving a preferred location and orientation information based on the scores.

According to yet other disclosed embodiments, a method of determining a preferred location and orientation of a wireless broadband router includes receiving by a controller a first downlink signal strength measurement corresponding to a first location and orientation of the wireless broadband router. The method includes receiving by the controller a first uplink signal strength measurement corresponding to the first location and orientation of the wireless broadband router. The method includes receiving by the controller downlink and uplink traffic load information. The method includes determining a first score responsive to the first downlink and uplink signal strength measurements and the downlink and uplink traffic load information and transmitting the first score to the wireless broadband router. The method includes receiving by the controller a second downlink signal strength measurement corresponding to a second location and orientation of the wireless broadband router. The method includes receiving by the controller a second uplink signal strength measurement corresponding to the second location and orientation of the wireless broadband router. The method includes receiving by the controller downlink and uplink traffic load information. The method includes determining a second score responsive to the second downlink and uplink signal strength measurements and the downlink and uplink traffic load information. The method includes transmitting the second score to the wireless broadband router.

### BRIEF DESCRIPTION OF THE DRAWINGS

FIG. 1 illustrates an exemplary wireless system according to disclosed embodiments.

FIG. 2 illustrates a wireless broadband router according to disclosed embodiments.

FIGS. 3 and 4 are flow diagrams of methods according to disclosed embodiments.

FIGS. 5A, 5B-8 illustrate locations and orientations of a wireless broadband router.

FIG. 9 is a flow diagram of a method according to disclosed embodiments.

### DETAILED DESCRIPTION

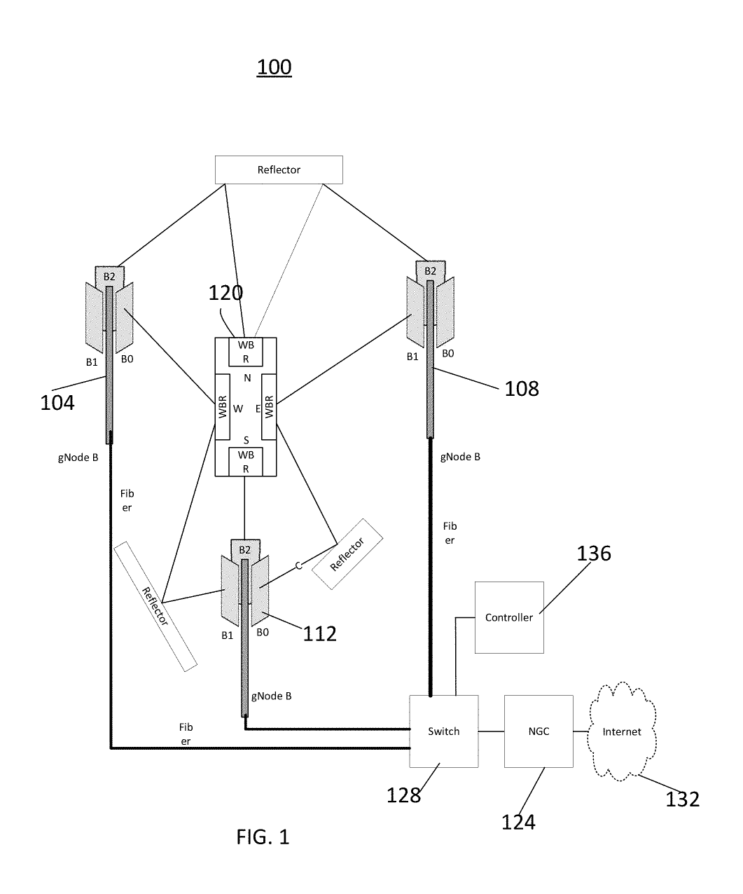

FIG. 1 illustrates a wireless system 100 in accordance with disclosed embodiments. The system 100 includes radio base stations 104, 108 and 112 referred to as gNodeBs that wirelessly communicate with a wireless broadband router (WBR) 120 which may be installed inside or outside a residential or a commercial building.

According to some disclosed embodiments, each radio base station implements three sectors, B0, B1 and B2. In other embodiments the radio base station may implement any suitable number of sectors (e.g., 2, 4, 5, 6). The radio base stations 104, 108 and 112 are connected to a communication network 124, which may be a Next Generation Core (NGC) network), via a switch or a router 128. The network 124 is connected to the Internet 132. The radio base stations 104, 108 and 112 also communicate control messages with a controller 136.

According to some disclosed embodiments, the controller 136 determines a preferred or optimum location and orientation of the WBR 120 based on information received from the WBR 120 and also from the base stations 104, 108, 112. The controller 136 collects information about the WBR 120 which may be installed inside or outside a residential or a commercial building. The controller 136 may receive the information from the base stations 104, 108, and 112 through one or more message exchanges. The received information may be analyzed in the context of the geographical location (thick trees, high-rise buildings, other base stations, potentially interfering WBRs in neighboring homes) of the premise where the WBR 120 is installed. The controller 136 may consider other information such as, for example, weather, foliage density, etc. and determine an optimal location and/or orientation of the WBR.

According to some disclosed embodiments, the controller 136 may be integrated into one or more of the radio base stations 104, 108 and 112. Although the controller 136 is shown remote from the radio base stations 104, 108 and 112, in some embodiments, the controller 136 may reside inside one or more of the radio base stations 104, 108 and 112.

According to disclosed embodiments, the wireless broadband router 120 provides high-speed access to communication devices inside the residential or commercial building. The communication devices may, for example, be smartphones, wearable devices, laptop computers, desktop computers, augmented reality/virtual reality (AR/VR) devices or any other communication devices.

Referring to FIG. 1, when the wireless broadband router 120 is facing North, it receives signals from sector B2 of the radio base stations 104 as well as from the sector B2 of the radio base station 108. In both these wireless links, there is no direct path and the received signals follow a reflected non-line-of-sight (NLOS) path caused by a reflector which may be a building or any other object that reflects RF signals. When the wireless broadband router 120 is facing East, it receives reflected a NLOS signal from the sector B0 of the radio base stations 112 and a direct signal from the sector B1 of the radio base station 108. When the wireless broadband router 120 is facing South, it receives a direct signal from the sector B2 of the radio base station 112. When the wireless broadband router 120 is facing West, it receives a direct signal from the sector B0 of the radio base station 104 and a reflected NLOS signal from the sector B1 of the radio base station 112.

Referring to FIG. 1, the controller 136 exchanges control messages with the radio base stations 104, 108 and 112. The controller 136 also exchanges control messages with the wireless broadband router 120 via one or more of the radio base stations. These control messages may, for example, include received signal strengths reports for the base stations/sectors/beams that the wireless broadband router 120 can measure, as well as commands for the wireless broadband router 120 to perform certain tasks.

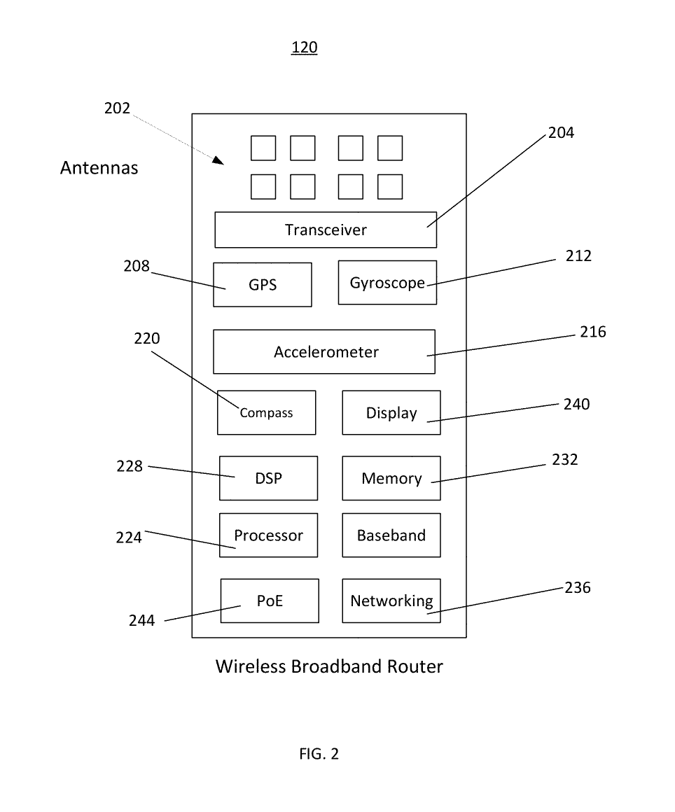

FIG. 2 illustrates functions implemented by the wireless broadband router 120 according to some disclosed embodiments. The wireless broadband router 120 implements an antenna array 202 configured to transmit and receive signals. According to some embodiments, the antenna array 202 may include one or more antennas configured to operate in the millimeter wave bands and may include one or more antennas configured to operate in the sub-7 GHz bands. The wireless broadband router 120 also implements a transceiver 204 that transmits data and control signals to the radio base stations and receives data and control signals transmitted by the radio base stations. The wireless broadband router 120 also implements a receiver 208 for satellite based positioning such as a GPS receiver and antennas that are used to determine the location of the wireless broadband router 120. The location information can be further refined by using other location methods such as cellular and Wi-Fi based location services. The wireless broadband router may also utilize various sensors such as a gyroscope 212, an accelerometer 216, and a compass 220. The signals from these sensors are used to determine the orientation of the broadband router 120 and may serve to associate the performance of a wireless link with a specific orientation. Thus, the system may provide users with indications regarding possible movements in the orientation, which may be the cause for performance degradation. The capability to read orientation may also serve to guide users towards a direction in which the multi-radio base stations (multi-gNodeB system) can provide the highest reliability. Such orientation may be chosen such that multiple radio base stations may offer acceptable coverage, rather than being chosen such that one particular radio base station is received at a maximal signal level. The other functions implemented by the wireless broadband router 120 include baseband processing 224, digital signal processing 228, communications protocol processing, memory 232, networking and routing functions 236. The wireless broadband router may also include additional functionalities such as a display, a camera 240 and power over ethernet functionality 244.

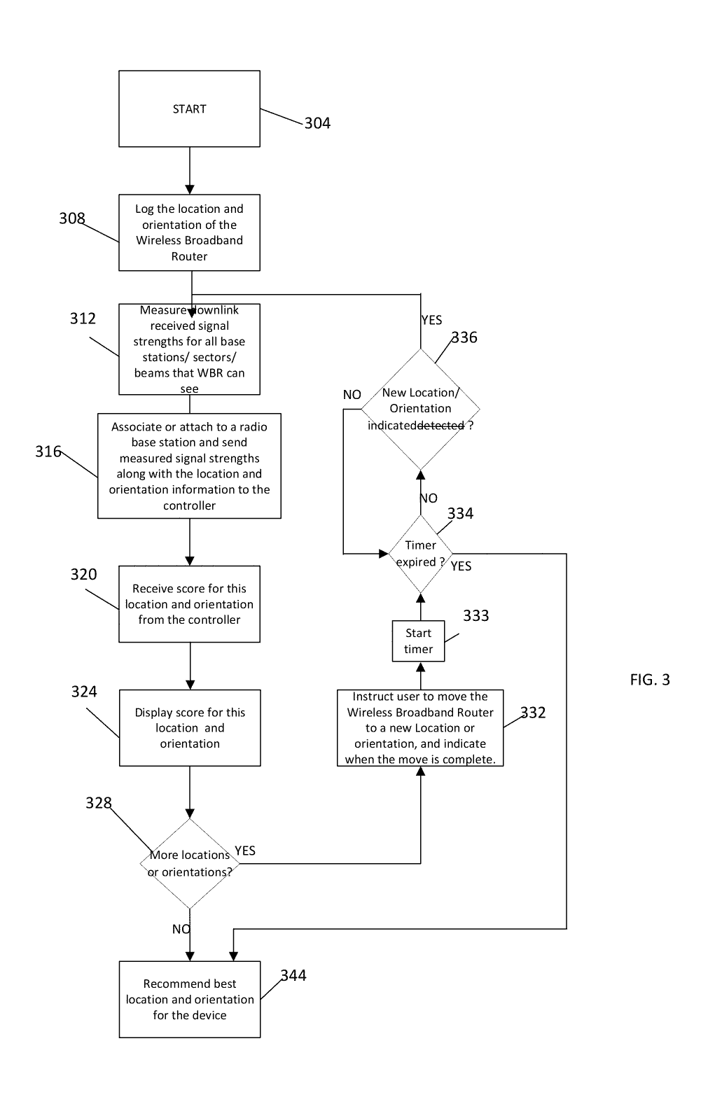

FIG. 3 is a flow diagram of a method of determining a preferred or optimum location and orientation of the wireless broadband router 120 according to some disclosed embodiments. In a step 304, the wireless broadband router is powered ON (i.e., start), and in a step 308 the wireless broadband router 120 determines (i.e., identifies) and records or logs its current location and orientation. In a step 312, the wireless broadband router 120 measures downlink received signal strengths for the radio base stations, sectors or beams that it can receive. In a step 316, the wireless broadband router 120 associates or attaches to a radio base station and sends the measured signal strengths along with the location and orientation information to the controller 136.

In a step 320, the wireless broadband router 120 receives a score for the current location and orientation from the controller 136, and in a step 324 communicates the score to a user. The score, also referred as a connectivity score, may be in a numerical format (e.g., a number between 1 and 100), or it may be in the form of a qualitative assessment (e.g., poor, fair, good, very good and excellent). The score is calculated based on, among others, measured downlink signal strengths. For example, the score may be communicated to a user via a display on the wireless broadband router 120 or an application running on a second device with a display such as a smartphone or a Tablet.

In a step 328, the user is prompted to respond if there are more locations or orientations that are to be evaluated. Exemplary means for such prompting/communication to the user may be as described earlier, i.e., via a display on the wireless broadband router 120 or an application running on a second device with a display such as a smartphone or a Tablet. Exemplary means for the user to respond to such prompting may be via a keypad on the wireless broadband router 120, or via a keypad application running on a second device with a display such as a smartphone or a tablet. If the user response indicates that more WBR locations or orientations are to be evaluated, in a step 332, the user is instructed to move the wireless broadband router 120 to a new location or orientation, and is prompted to indicate when the move is done. Such prompting may be via a dialog box, wherein the user has an option to indicate that the move is complete. In some embodiments, the prompt may also indicate to the user how long the system will wait for the move to be made and indicated, before assuming that no further WBR locations/orientations are to be evaluated. In alternate embodiments, the WBR may autonomously detect the move to a new WBR location or orientation. In a step 333, the WBR starts a timer waiting for the updated WBR location to be indicated, and evaluates if the timer expired in step 334. If the timer expired, the flow moves to step 344. If the timer did not expire, in a step 336, if a new location or orientation is indicated or detected at the WBR, the flow returns to the step 312. Thus, the process may be repeated for multiple locations and multiple orientations until the controller determines the best location and orientation (i.e. the location and the orientation with the best connectivity score) for the wireless broadband router 120. In a step 344, the controller recommends the best location and orientation for the wireless broadband router. According to some disclosed embodiments, a score may computed based not only on signal level but also on the number of gNodeB signals that may be picked up at a given orientation. In some disclosed embodiments, the computation for the determination of the best location and orientation may be performed by the wireless broadband router 120 instead of the controller 136.

According to some disclosed embodiments, the foregoing steps may be repeated for a plurality of base stations and the resulting connectivity scores may be compared. Based on the comparison, one of the base stations may be selected. For example, the base station that provides the best connectivity score may be selected. In some embodiments, the downlink signal strength reported by the wireless broadband router 120, in exemplary units of dbm (decibels per milliwatt), may be mapped to a qualitative connectivity score as in Table Y1. It is to be understood that signal strength measurements reported using units different from dbm may be mapped to dbm units allowing re-use of Table Y1.

TABLE Y1

| | Qualitative |
|---|---|
| | connectivity |
| Range of Reported downlink signal strength, dbm | score |
| Reported downlink signal strength >= −50 | Excellent |
| −50 < Reported downlink signal strength <= −60 | Very good |
| −60 < Reported downlink signal strength <= −70 | Good |
| −70 < Reported downlink signal strength <= −80 | Fair |
| −80 < Reported downlink signal strength <= −90 | Poor |
| Reported downlink signal strength < −90 | Very poor |

In some embodiments, the downlink signal strength reported by the wireless broadband router 120, in exemplary units of dbm, may be converted to numerical connectivity scores using a formula that yields larger scores for larger reported values. In some embodiments, the exemplary formula:

Numerical connectivity Score=100+(downlink signal strength,dbm)

may be used. The connectivity scores obtained for some exemplary values of reported measured downlink signal strength are shown in Table Y2.

TABLE Y2

| Reported downlink signal strength, dbm | Numerical connectivity score |
|---|---|
| −50 | 50 |
| −60 | 40 |
| −70 | 30 |
| −80 | 20 |
| −90 | 10 |

In some embodiments, the controller may utilize both the downlink signal strength measurement reported by the wireless broadband router 120, as well as uplink signal strengths measured by a base station when the wireless broadband router is connected to it, in order to calculate a connectivity score. In such embodiments, the qualitative or numerical connectivity scores may be arrived at as described earlier in this section, but with the “downlink signal strength measurement” replaced by a certain mathematical function of the downlink and uplink signal strength measurements, and denoted as a “joint downlink and uplink signal strength measurement”. Such an exemplary mathematical formula is shown below:

Joint downlink and uplink signal strength measurement,dbm=a*(downlink signal strength measurement,dbm)+b*(downlink signal strength measurement,dbm), where ‘a’ and ‘b’ are real numbers.

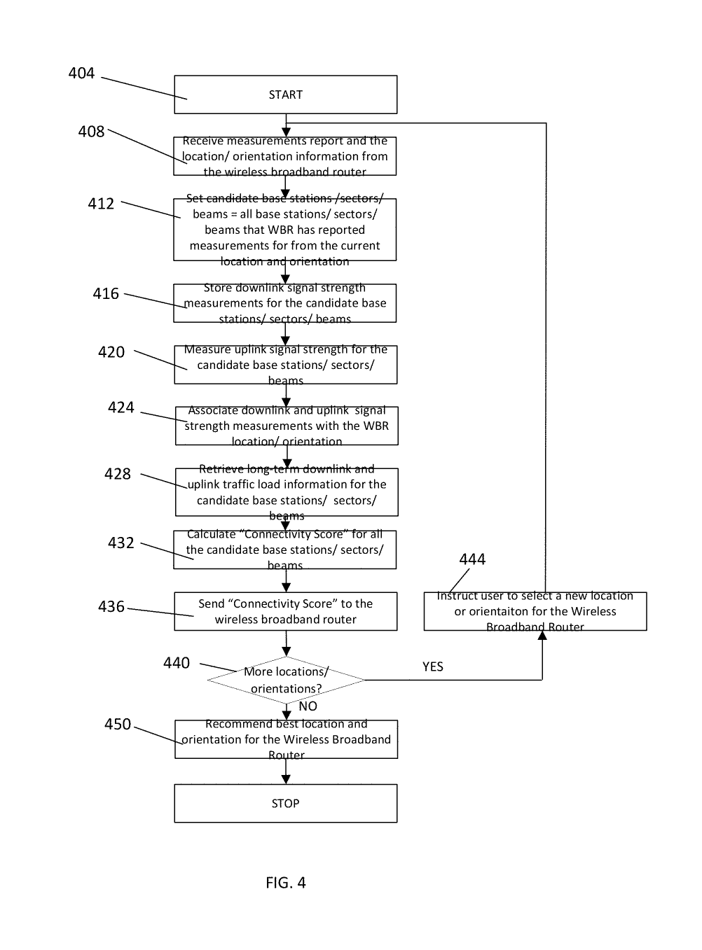

FIG. 4 is a flow diagram of a method used by the controller 136 to determine a preferred or optimum location and orientation of the wireless broadband router 120. The flow starts in a step 404, and in a step 408 the controller 136 receives downlink signal strength measurements as well as the wireless broadband router location and orientation information from the wireless broadband router 120.

According to some disclosed embodiments, a beam, a sector and a base station is selected to which the WBR 120 will attach. For this selection the controller composes a candidate set to choose from. In a step 412, the controller 136 populates the candidate beams, candidate sectors and candidate base stations with all the beams, sectors and the base stations for which the WBR 120 has reported measurements from the current location.

In a step 416, the controller 136 stores downlink signal strength measurements for the candidate base stations/sectors/beams and instructs radio base stations to measure the uplink signal strength for the candidate base stations/sectors/beams. In a step 420, the controller receives the uplink signal strength measurements from the radio base stations and in step 424 associates downlink and uplink signal strength measurements with the current location and orientation of the wireless broadband router 120. In a step 428, the controller retrieves the downlink and uplink traffic load information for the candidate base stations/sectors/beams, and in a step 432 the controller uses this information along with downlink and uplink signal strength measurements to calculate connectivity scores for all the candidate base stations/sectors/beams.

In a step 436, the controller sends the computed connectivity score to the wireless broadband router 120. In a step 440, if there are more locations/orientations, the flow moves to a step 444 in which the user is instructed to select a new location or orientation for the wireless broadband router and the flow returns to the step 408. Thus, the process may be repeated for multiple locations and orientations until the controller 136 determines there are no more locations/orientations and recommends the best location and orientation for the wireless broadband router in a step 450.

According to yet other disclosed embodiments, the connectivity scores may be determined solely from the downlink signal strengths. Thus, according to some embodiments, the connectivity scores may be calculated from measured downlink signal strength measurements as well as the wireless broadband router location and orientation information from the wireless broadband router (step 408). According to yet other disclosed embodiments, the connectivity scores may be calculated by the broadband router itself based on measured downlink signal strengths.

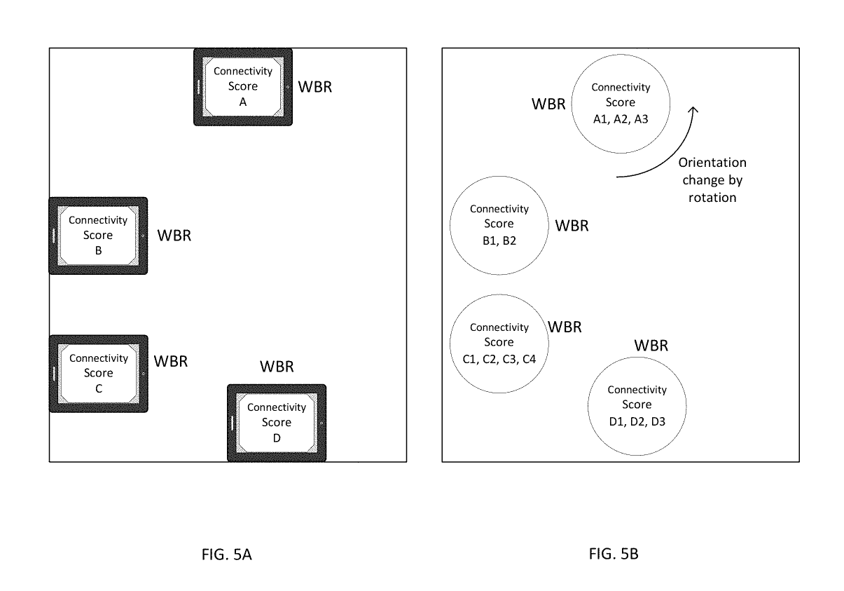

FIG. 5A illustrates four different locations and orientations for the wireless broadband router 120 at customer or business premises. Upon reception of the connectivity scores from the controller 136, the wireless broadband router 120 displays the connectivity scores on its display, and/or transmits the scores to a connected device, such as a tablet or a smartphone, which may be done via Bluetooth, WiFi, or any other connectivity means. Referring to FIG. 5A, the connectivity scores are displayed for locations and/or orientations A, B, C and D. The connectivity scores can be displayed as numbers, letters, graphics or a combination of these. In other embodiments, the connectivity scores can be calculated locally in the wireless broadband router 120. In yet other embodiments, the wireless broadband router 120 can alter the connectivity scores based on some local measurements or metrics. This final connectivity scores are then displayed on the display.

FIG. 5B illustrates four different locations and one more orientations for a given location for the wireless broadband router 120 at customer or business premises. In this exemplary embodiment, WBR is of a circular shape and its orientation can be changed by rotation. For a given location, multiple connectivity scores are calculated. For example, for the WBR location A, three score A1, A2 and A3 are calculated. Upon reception of the connectivity scores from the controller 136, the wireless broadband router 120 displays the connectivity scores on its display, and/or transmits the scores to a connected device, such as a tablet or a smartphone, which may be done via Bluetooth, WiFi, or any other connectivity means. Referring to FIG. 5B, the connectivity scores are displayed for locations and/or orientations A, B, C and D. The connectivity scores can be displayed as numbers, letters, graphics or a combination of these. In other embodiments, the connectivity scores can be calculated locally in the wireless broadband router 120. In yet other embodiments, the wireless broadband router 120 can alter the connectivity scores based on some local measurements or metrics. This final connectivity scores are then displayed on the display.

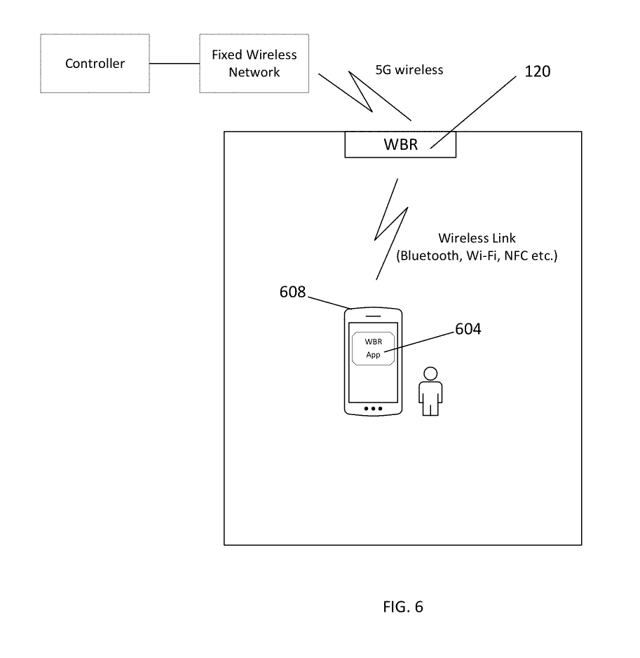

In another embodiment, an external device such as a smartphone, a Tablet, a laptop computer or a smart watch can be used to display the connectivity score. FIG. 6 illustrates an example where an application 604 (referred to as Wireless Broadband Router Application (WBR App)) running on a smartphone 608 communicates with the wireless broadband router 120 at a customer or business premises. The smartphone 608 communicates with the wireless broadband router 120 using a wired data link such as USB or a wireless link such as Wi-Fi, Bluetooth or Near Field Communications (NFC). Upon reception of the connectivity scores from the controller 136, the wireless broadband router 120 forwards the scores to the WBR App 604 running on the smartphone 608. The WBR App 604 then displays the connectivity scores as numbers, letters, graphics or a combination of these. In other embodiments, the connectivity scores can be calculated locally in the wireless broadband router 120. In yet other embodiments, the wireless broadband router 120 can alter the final connectivity scores based on some local measurements or metrics. This final connectivity scores are then displayed on the display.

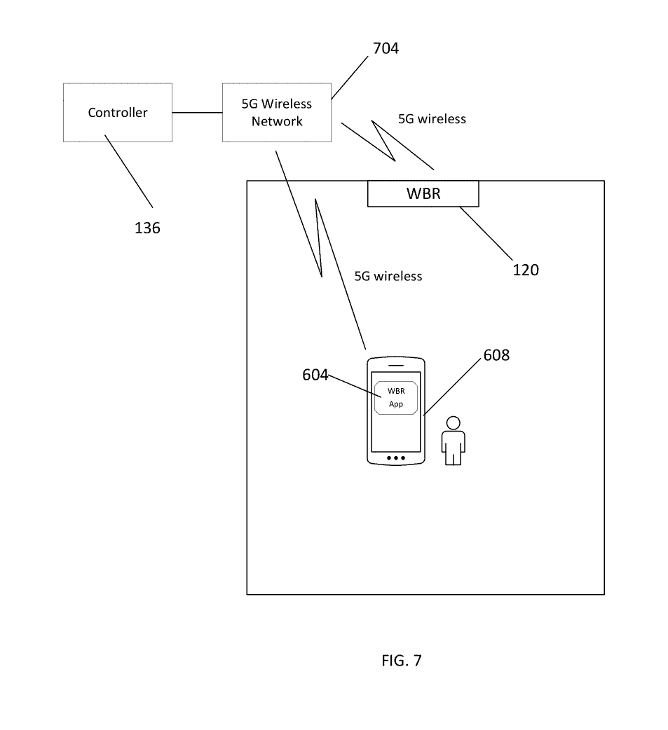

In another embodiment illustrated in FIG. 7, the WBR App 604 running on the smartphone 608 directly communicates with the controller 136 over the same 5G wireless broadband network 704 as used by the wireless broadband router 120. In this example, the WBR App 604 running on a smartphone first associates itself with the wireless broadband router 120 at the customer premises using, for example, Wi-Fi, Bluetooth or NFC wireless link. In other embodiments, a code associated with the wireless broadband router 120 or a MAC address of the wireless broadband router 120 can be manually entered in the WBR App 604. In other embodiments, the WBR App 604 instructs the user to scan a bar code on the wireless broadband router 120 to associate itself with the wireless broadband router 120. After association, the WBR App 604 can request the connectivity scores for the desired wireless broadband router from the controller 136. Upon reception of the connectivity scores from the controller, the WBR App 604 displays the connectivity scores as numbers, letters, graphics or a combination of these. In other embodiments, the connectivity scores can be calculated locally in the wireless broadband router. In yet other embodiments, the wireless broadband router can alter the final connectivity score based on some local measurements or metrics. This final connectivity score is then displayed for the user on the display.

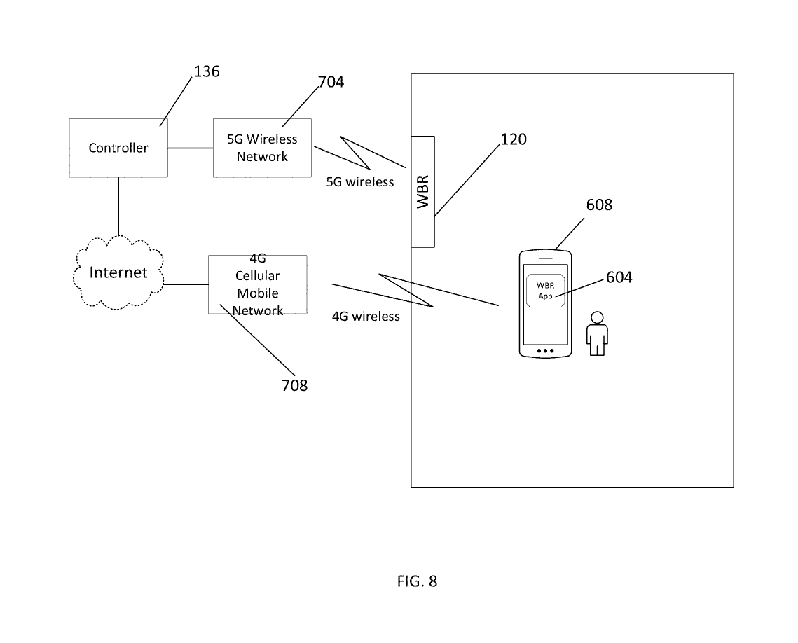

In another embodiment shown in FIG. 8, the Wireless Broadband Router Application (WBR App) 604 running on the smartphone 608 communicates with the controller 136 over a separate network such as a 4G LTE wireless broadband network 708, which is different from the 5G network 704 used by the wireless broadband router 120. In this example, the WBR App 604 running on the smartphone 608 first associates itself with the wireless broadband router 120 at the customer premises using, for example, Wi-Fi, Bluetooth or NFC wireless link. In other embodiments, a code associated with the wireless broadband router 120 or the MAC address of the wireless broadband router 120 can be manually entered in the WBR App 604. In other embodiments, the WBR App 604 instructs the user to scan a bar code on the wireless broadband router 120 to associate itself with the wireless broadband router. After association, the WBR App 604 can request the connectivity scores for the desired wireless broadband router from the controller 136 over the 4G LTE network 708. Upon reception of the connectivity scores from the controller 136, the WBR App 604 displays the connectivity scores as numbers, letters, graphics or a combination of these. In other embodiments, the connectivity scores can be calculated locally in the wireless broadband router 120. In yet other embodiments, the wireless broadband router 120 can alter the final connectivity scores based on some local measurements or metrics. This final connectivity score is then displayed on the display.

In yet another embodiment, the controller 136 utilizes the known geographical location of the premises where the wireless broadband router 120 is being mounted to compose location and orientation recommendations. After the user unpacks the wireless broadband router 120 out of the box and tries the first location on the premises, the wireless broadband router 120 measures the downlink RSSI from all sectors of all the base stations that are visible to the wireless broadband router 120 and sends the measured information, along with the current location and orientation of the wireless broadband router 120 to the controller 136. The controller 136, which is connected to the internet, has a much wider view of the network. Based on the location information received from the wireless broadband router 120, the controller 136 creates a virtual map of the wireless broadband router 120 amidst the known locations of the network provider's base stations. In addition, the controller 136 factors in information such as location of other structures (including buildings, large thick trees etc.) that may block the line of sight to the premises and prepares an ordered list of suggested mounting locations. This list is communicated either through the display on the wireless broadband router 120 or through the WBR application 604. The recommended mounting locations may, for example, be in the form of directions (e.g., try a window on the North-East side) or in the form of visual pointers on the WBR application 604.

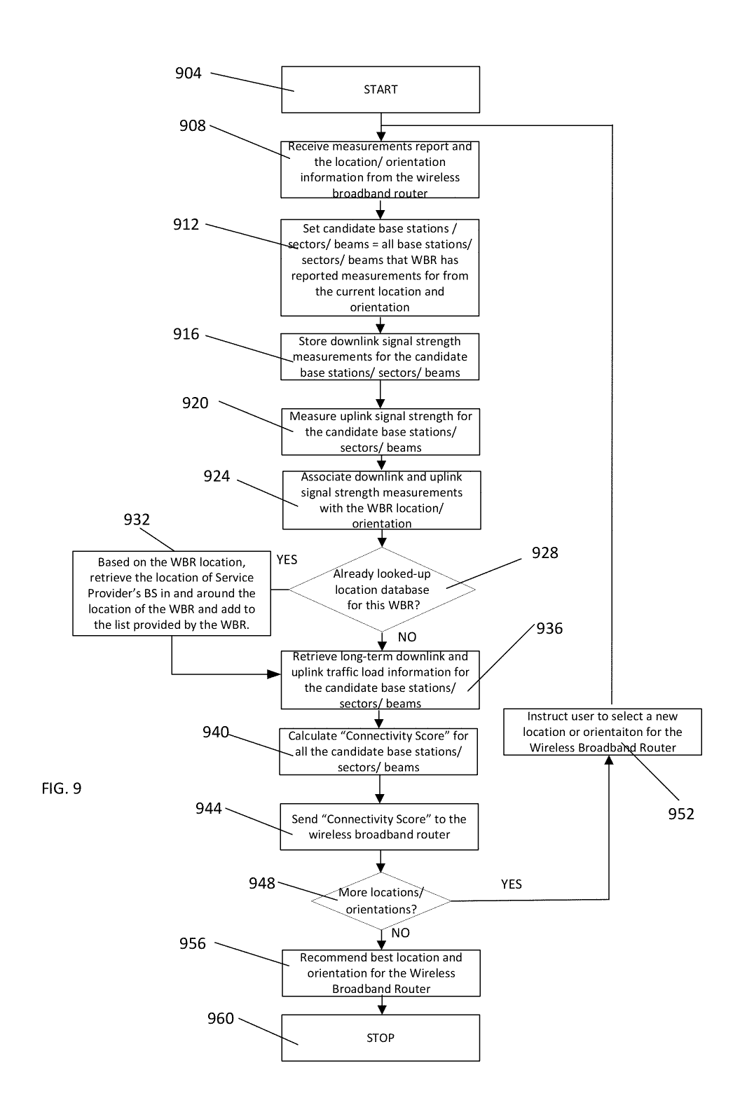

FIG. 9 is a flow diagram of a method according to disclosed embodiments. The flow starts in a step 904, and in a step 908 the controller 136 receives measurement reports and location/orientation information from the broadband router 120. As discussed before, according to some disclosed embodiments, the beam, the sector and the base station is selected to which the WBR 120 will attach. The controller 136 composes a candidate set to choose from. In a step 912, the controller 136 populates the candidate beams, candidate sectors and candidate base stations with all the beams, sectors and the base stations for which the WBR 120 has reported measurements from the current location

In a step 916, downlink signal strength measurements for the candidate base stations/sectors/beams are stored by the controller. In a step 920, uplink signal strength for the candidate base stations/sectors/beams are measured by the controller 136. In a step 924, the controller associates the downlink and uplink signal strength measurements with the wireless broadband router location/orientation. In a step 928, the controller determines if the location database for this wireless broadband router has already been looked up? If the location database for this wireless broadband router has already been looked up, the flow moves to a step 932 where based on the wireless broadband router location, a location service provider's base station in and round the location of the wireless broadband router is retrieved from the database at the controller and added to the list provided by the wireless broadband router. Otherwise, the flow moves to a step 936 where long-term downlink and uplink traffic load information for the candidate base stations/sectors/beams are retrieved from the database at the controller.

In a step 940, connectivity scores for candidate base stations/sectors/beams are calculated by the controller 136. In a step 944, connectivity scores are sent by the controller 136 to the wireless broadband router 120. In a step 948 a determination is made if there are more locations/orientations. If there are more locations/orientations, in a step 952 the user is instructed to select a new location or orientation for the wireless broadband router and the flow returns to the step 908. Otherwise, in a step 956 recommendations for best location and orientation for the wireless broadband router is made by the controller 136. The flow ends in a step 956.

Those skilled in the art will recognize that, for simplicity and clarity, the full structure and operation of all systems suitable for use with the present disclosure are not being depicted or described herein. Instead, only so much of a system as is unique to the present disclosure or necessary for an understanding of the present disclosure is depicted and described. The remainder of the construction and operation of the disclosed systems may conform to any of the various current implementations and practices known in the art.

Those skilled in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

1. A method of determining a preferred location and orientation of a wireless broadband router, comprising:
measuring by the wireless broadband router a first received downlink signal strength corresponding to a first location and orientation;
transmitting by the wireless broadband router the first received downlink signal strength;
receiving a first score responsive to the first downlink signal strength;
measuring by the wireless broadband router a second received downlink signal strength corresponding to a second location and orientation;
transmitting by the wireless broadband router the second received downlink signal strength;
receiving a second score responsive to the second received downlink signal strength; and
receiving a preferred location and orientation information based on the scores.

2. The method of claim 1, further comprising determining by the wireless broadband router its location and orientation.

3. The method of claim 1, wherein the wireless broadband router is configured to receive millimeter wave band downlink signals from a radio base station.

4. The method of claim 1, wherein the wireless broadband router is configured to transmit millimeter wave band uplink signals to a radio base station.

5. The method of claim 1, wherein the wireless broadband router is configured to transmit sub-7 GHz band uplink signals to a radio base station.

6. The method of claim 1, wherein the preferred location and orientation is determined by comparing the scores.

7. A method of determining a preferred location and orientation of a wireless broadband router, comprising:
determining by the wireless broadband router its first location and orientation;
measuring by the wireless broadband router first received downlink signal strength corresponding to the first location and orientation;
transmitting by the wireless broadband router the first received downlink signal strength and the first location and orientation information;
receiving a first score corresponding to the first location and orientation;
moving the wireless broadband router to a second location and orientation and determining the second location and orientation;
measuring by the wireless broadband router a second received downlink signal strength corresponding to the second location and orientation;
transmitting by the wireless broadband router the second received downlink signal strength and the second location and orientation information;
receiving a second score corresponding to the second location and orientation; and
receiving preferred location and orientation information based on the scores.

8. The method of claim 7, wherein the location is determined by a GPS receiver.

9. The method of claim 7, wherein the orientation is determined by a gyroscope.

10. The method of claim 7, wherein the orientation is determined by an accelerometer.

11. The method of claim 7, wherein the wireless broadband router is configured to receive millimeter wave band downlink signals from the radio base station.

12. The method of claim 7, wherein the wireless broadband router is configured to transmit millimeter wave band uplink signals to the radio base station.

13. The method of claim 7, wherein the wireless broadband router is configured to transmit sub-7 GHz band uplink signals to the radio base station.

14. The method of claim 7, further comprising transmitting by the measured signal strengths information and the location and orientation information to a controller.

15. The method of claim 7, further comprising receiving the preferred location and orientation from a controller.

16. The method of claim 7, wherein the controller is located inside a radio base station.

17. The method of claim 7, wherein the controller is located remote from the radio base station.

18. The method of claim 7, further comprising displaying the optimum location and orientation.

19. A method of determining a preferred location and orientation of a wireless broadband router, comprising:
receiving by a controller a first downlink signal strength measurement corresponding to a first location and orientation of the wireless broadband router;
receiving by the controller a first uplink signal strength measurement corresponding to the first location and orientation of the wireless broadband router;
receiving by the controller downlink and uplink traffic load information;
determining a first score responsive to the first downlink and uplink signal strength measurements and the downlink and uplink traffic load information; and
transmitting the first score to the wireless broadband router.

20. The method of claim 19, further comprising:
receiving by the controller a second downlink signal strength measurement corresponding to a second location and orientation of the wireless broadband router;
receiving by the controller a second uplink signal strength measurement corresponding to the second location and orientation of the wireless broadband router;
receiving by the controller downlink and uplink traffic load information;
determining a second score responsive to the second downlink and uplink signal strength measurements and the downlink and uplink traffic load information; and
transmitting the second score to the wireless broadband router.

21. The method of claim 19, further comprising:
determining a preferred location and orientation of the wireless broadband router based on the scores;
transmitting the preferred location and orientation information to the wireless broadband router; and
displaying the preferred location and orientation information.

22. The method of claim 19, wherein the preferred location and orientation is determined based on a comparison of the scores.

23. The method of claim 19, wherein the wireless broadband router is configured to receive millimeter wave band downlink signals from a radio base station.

24. The method of claim 19, wherein the wireless broadband router is configured to transmit millimeter wave band uplink signals to a radio base station.

25. The method of claim 19, wherein the wireless broadband router is configured to transmit sub-7 GHz band uplink signals to a radio base station.

26. The method of claim 19, wherein the controller is located inside a radio base station.

27. The method of claim 19, wherein the controller is located remote from a radio base station.
